(19) United States
(12) Patent Application Publication
(10) Pub. No.: US 2024/0302829 A1
(43) Pub. Date: Sep. 12, 2024

(54) PROCESS MODEL MANAGEMENT SYSTEM AND PROCESS MODEL MANAGEMENT METHOD

(71) Applicant: Hitachi, Ltd., Tokyo (JP)

(72) Inventors: Riku KAWAMURA, Tokyo (JP); Hitoshi ISHIDA, Tokyo (JP); Takehiro HAGIWARA, Tokyo (JP)

(21) Appl. No.: 18/367,932

(22) Filed: Sep. 13, 2023

(30) Foreign Application Priority Data
Mar. 8, 2023 (JP) 2023-035800

(51) Int. Cl. G05B 19/418

(52) U.S. Cl. CPC G05B 19/41885; G05B 2219/35499

(57) ABSTRACT

A process model management system includes a processor and a storage device, the storage device being configured to store actual data of tasks at a manufacturing site and master data including design information of the tasks. The processor is configured to generate an actual process model based on the actual data, generate a master process model based on the master data, generate a synthetic process model by synthesizing the actual process model and the master process model, when the actual data is changed, detect a difference of the actual process model due to the change of the actual data, when the master data is changed, detect a difference of the master process model due to the change of the master data, detect a difference of the synthetic process model due to the change of the actual data or the master data, and output a notification based on the detected difference.

### CLAIM OF PRIORITY

The present application claims priority from Japanese patent application JP 2023-035800 filed on Mar. 8, 2023, the content of which is hereby incorporated by reference into this application.

### TECHNICAL FIELD

The present invention relates to technology for managing process models.

### BACKGROUND ART

In the manufacturing industry, there are cases where a manufacturing process is modeled and site data is managed in association with the model (that is, the process model). Such a management technique is disclosed in JP2019-153051A (PTL 1), for example. PTL 1 describes, “an information collection and display system connected to a data generation device that generates site data and a transaction data accumulation unit that stores the site data, the system including an association data accumulation unit that stores association data defining association of each of a plurality of pieces of information included in the site data, an association data search unit that searches for second information associated with first information included in the plurality of pieces of information based on the association data, and a user interface that displays a connection relation of the plurality of pieces of information associated by the association data, in which the association data search unit searches for the second information associated with the first information displayed on the user interface and displays the first information and the second information on the user interface with the connection relation of the plurality of pieces of information”.

A technique for analyzing task is disclosed in JP2020-126301A (PTL 2), for example. PTL 2 discloses, “CPU of the task analysis device generates a current task process based on predetermined work information on a current work of a target task input by a user operation, extracts a difference between the generated current task process and a task process model corresponding to the current task process prepared in advance, and causes a display unit to display a plurality of improvement proposals for reducing the extracted difference together with the corresponding difference”.

### CITATION LIST

### Patent Literature

PTL 1: JP2019-153051A
PTL 2: JP2020-126301A

### SUMMARY OF INVENTION

### Technical Problem

As described above, by modeling the manufacturing process and managing the site data in association with the process model, it becomes possible to acquire data through the process model, making it easier to analyze data across the entire task process. Here, when modeling the manufacturing process, as the number of processes and the number of tasks included in the processes increase, it is difficult to build a process model manually, and accordingly, there are cases where the process model is automatically generated based on the actual data acquired from the manufacturing site. However, here, for example, when the work process at the site is changed, the actual data acquired from the site may not match the process model, and there are cases where it is not possible to acquire specific data through the process model.

Meanwhile, process models can also be generated based on master data created when designing the process. However, here too, the actual data acquired from the site may not match the process model due to changes in the work process at the site. Mismatch between the actual data and the process model also occurs when the site does not correspond to changes in the master data.

When the process model does not match the actual conditions of the site as described above, appropriate data cannot be acquired through the process model, in which errors, delays, and the like in data analysis occur, resulting in reduced productivity.

An object of the present invention is to manage and update the actual data and the master data, thereby enabling data acquisition from a process model that matches the manufacturing site, thereby improving productivity.

### Solution to Problem

To solve at least one of the problems described above, the present invention provides a process model management system including a processor and a storage device, in which the storage device is configured to store actual data indicating actual performance of tasks executed at a manufacturing site and master data including design information on an order of tasks to be executed, and the processor is configured to generate an actual process model including information on an execution order of the tasks based on the actual data, generate a master process model including information on the execution order of the tasks based on the master data, generate a synthetic process model that includes both information on the execution order of the tasks included in the actual process model and information on the execution order of the tasks included in the master process model, when the actual data is changed, detect a difference between a past actual process model generated based on the actual data before change and a new actual process model generated based on the actual data after change, when the master data is changed, detect a difference between a past master process model generated based on the master data before change and a new master process model generated based on the master data after change, detect a difference between a past synthetic process model generated based on the actual process model and the master process model before the actual data and the master data are changed and a new synthetic process model generated based on the actual process model and the master process model after one of the actual data and the master data is changed, and outputs a notification based on the detected difference.

### Advantageous Effects of Invention

According to one aspect of the present invention, it is possible to improve productivity by efficiently managing the process models.

Problems, configurations, and effects other than those described above will be apparent from the following description of the embodiments.

### BRIEF DESCRIPTION OF DRAWINGS

FIG. 1 is a block diagram showing an overview of process model management technology according to an embodiment of the present invention.

FIG. 2A is a block diagram showing an example of a configuration of a process model management system according to an embodiment of the present invention.

FIG. 2B is a block diagram showing an example of a hardware configuration of a computer system for implementing the process model management system according to an embodiment of the present invention.

FIG. 3 is a block diagram showing an example of a configuration of a process model management unit according to an embodiment of the present invention.

FIG. 4 is an explanatory diagram showing an example of data accumulated in an actual data accumulation unit of the process model management system according to an embodiment of the present invention.

FIG. 5 is an explanatory diagram showing an example of data accumulated in a master data storage unit of the process model management system according to an embodiment of the present invention.

FIG. 6 is an explanatory diagram showing an example of a process in which the process model management system according to an embodiment of the present invention generates an actual process model based on actual data.

FIG. 7 is an explanatory diagram showing an example of a process in which the process model management system according to an embodiment of the present invention generates a master process model based on master data.

FIG. 8A is a flowchart showing an example of a process executed by the process model management unit of the process model management system according to an embodiment of the present invention.

FIG. 8B is a flowchart showing an example of a process executed by the process model management unit of the process model management system according to an embodiment of the present invention.

FIG. 8C is a flowchart showing an example of a process executed by the process model management unit of the process model management system according to an embodiment of the present invention.

FIG. 9 is an explanatory diagram showing an example of a process executed by the process model management unit of the process model management system according to an embodiment of the present invention.

FIG. 10 is an explanatory diagram showing an example of a screen displayed when the actual process model is synchronized with the master process model by changing the actual process model in the process model management system according to an embodiment of the present invention.

FIG. 11A is an explanatory diagram showing an example of a screen displayed when the actual process model deviates from the master process model by changing the actual process model in the process model management system according to an embodiment of the present invention.

FIG. 11B is an explanatory diagram showing an example of a screen displayed when the actual process model deviates from the master process model by changing the actual process model in the process model management system according to an embodiment of the present invention.

FIG. 12 is an explanatory diagram showing an example of a screen displayed when the master process model is synchronized with the actual process model by changing the master process model in the process model management system according to an embodiment of the present invention.

FIG. 13 is an explanatory diagram showing an example of a screen displayed when the master process model deviates from the actual process model by changing the master process model in the process model management system according to an embodiment of the present invention.

### DESCRIPTION OF EMBODIMENTS

Hereinafter, using the drawings, embodiments of the present invention will be described in detail.

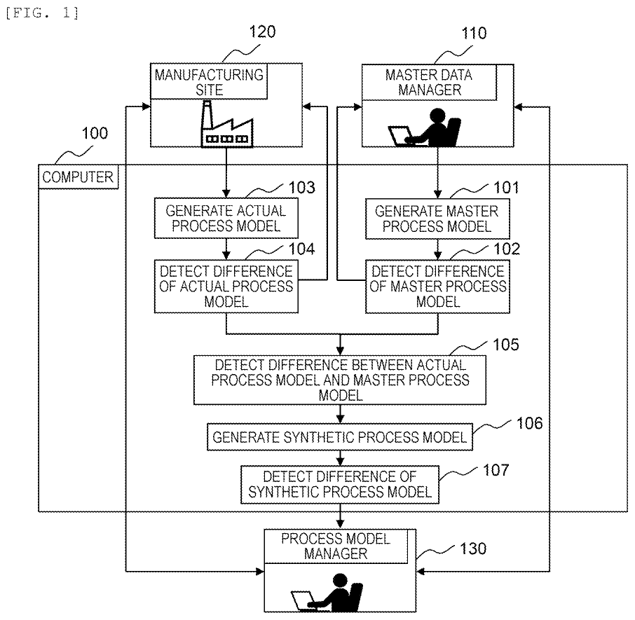

FIG. 1 is a block diagram showing an overview of process model management technology according to an embodiment of the present invention.

In the present embodiment, management of a process model that models a product manufacturing process at a manufacturing site 120 will be described.

A computer 100 generates a master process model based on master data input from a master data manager 110 (step 101). The master data is design information of the manufacturing process managed by the master data manager 110, and includes, for example, information defining an execution order of tasks configuring each process, an execution order of the processes, and the like. The process model generated based on the master data is referred to as a master process model. Examples of the master data and the master process model are described below.

When a master manager changes the master data, the master process model generated based on the master data is also changed. The computer 100 compares a newly generated master process model with a previously generated master process model, and detects any difference between the two models (step 102).

The computer 100 generates an actual process model based on actual data acquired from the manufacturing site 120 (step 103). The actual data is information on each task of each process of product manufacturing actually performed at the manufacturing site 120, and includes, for each product, information such as time when each task in each process was actually performed, relationship between processes, for example. The process model generated based on the actual data is referred to as an actual process model. Examples of the actual data and the actual process model are described below.

When the actual manufacturing process at the manufacturing site 120 (hereinafter also referred to as a ‘site process’) is changed, the actual data changes according to the change, and as a result, the generated actual process model is also changed. The computer 100 compares a newly generated actual process model with a previously generated actual process model, and detects any difference between the two models (step 104).

Then, the computer 100 compares the actual process model with the master process model, detects any difference between the process models (step 105), and generates a synthetic process model based on the detected difference (step 106). Then, the computer 100 compares a newly generated synthetic process model with a previously generated synthetic process model, detects any difference between the synthetic process models, and notifies the result to a process model manager 130.

The process model manager 130 recommends changes of the master data to the master data manager 110, and recommends changes of the site process to the manufacturing site, if necessary, based on the notified difference of the synthetic process models.

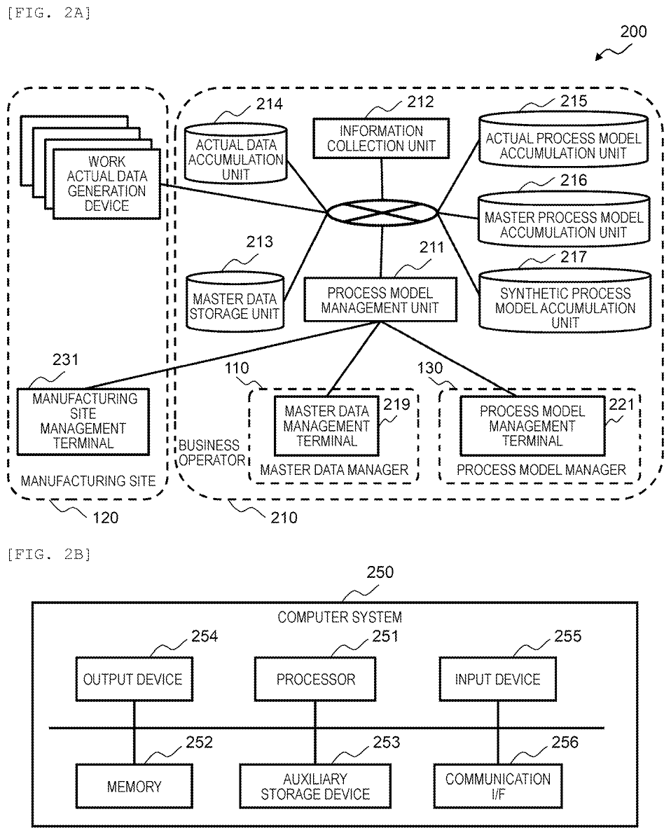

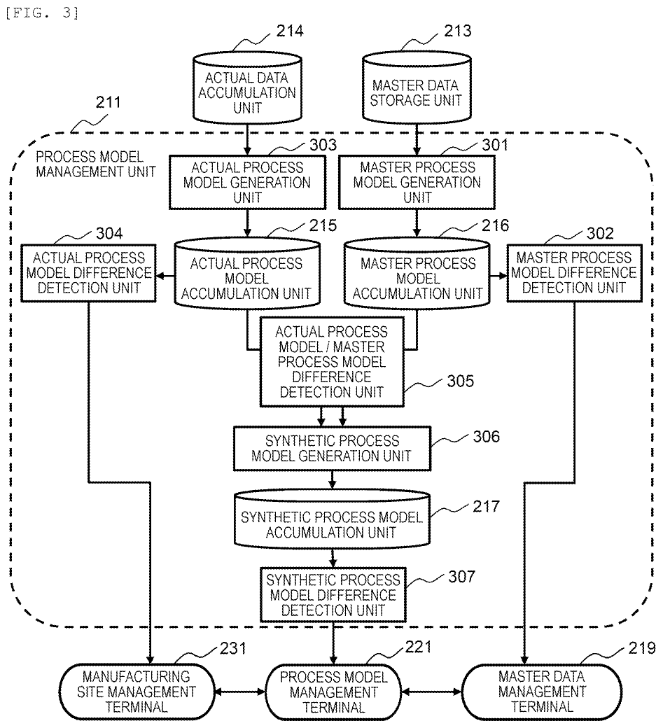

FIG. 2A is a block diagram showing an example of a configuration of a process model management system according to an embodiment of the present invention.

A process model management system 200 of the present embodiment is used by a business operator 210 who runs a business of manufacturing products at the manufacturing site 120. The process model management system 200 shown in FIG. 2 includes a process model management unit 211, an information collection unit 212, a master data storage unit 213, an actual data accumulation unit 214, an actual process model accumulation unit 215, a master process model accumulation unit 216, a synthetic process model accumulation unit 217, a master data management terminal 219, a process model management terminal 221, a manufacturing site management terminal 231, and a work actual data generation device 232.

The manufacturing site management terminal 231 is a terminal used by a manager or the like of the manufacturing site 120, and may receive a notification (for example, a recommendation to be described below) from the system of the business operator 210 and display the notification to the manager or the like of the manufacturing site 120, for example. The work actual data generation device 232 generates data indicating an actual performance of each task in each process at the manufacturing site 120 (in the present embodiment, the data is referred to as ‘actual data’). The manufacturing site management terminal 231 and the work actual data generation device 232 may be installed at the manufacturing site, and the work actual data generation device 232 may be installed for each piece of equipment that performs task in a process.

The information collection unit 212 collects the actual data from the work actual data generation device 232 and the master data from the master data management terminal 219, and stores the collected data in the actual data accumulation unit 214 and the master data storage unit 213, respectively. The master data management terminal 219 is a terminal used by the master data manager 110. For example, the master data manager 110 can operate the master data management terminal 219 to input the master data.

The process model management unit 211 generates a master process model based on the master data stored in the master data storage unit 213 and stores the generated model in the master process model accumulation unit 216. The process model management unit 211 generates an actual process model based on the actual data accumulated in the actual data accumulation unit 214 and stores the generated model in the actual process model accumulation unit 215. Then, the process model management unit 211 detects a difference between the master process model and the actual process model, generates a synthetic process model, stores the generated model in the synthetic process model accumulation unit 217, and transmits the result to the process model management terminal 221.

The process model management terminal 221 is a terminal used by the process model manager 130, and the process result at the process model management unit 211 is presented to the process model manager 130 via the process model management terminal 221, for example.

FIG. 2B is a block diagram showing an example of a hardware configuration of a computer system for implementing the process model management system 200 according to an embodiment of the present invention.

The system of the present embodiment shown in FIGS. 1 and 2A is configured with a computer system 250, for example. For example, the process model management unit 211, the information collection unit 212, the master data storage unit 213, the actual data accumulation unit 214, the actual process model accumulation unit 215, the master process model accumulation unit 216, and the synthetic process model accumulation unit 217 shown in FIG. 2A may correspond to the computer 100 shown in FIG. 1 and be implemented by the computer system 250 shown in FIG. 2B.

The computer system 250 includes a processor 251, a memory (main storage device) 252, an auxiliary storage device 253, an output device 254, an input device 255, and a communication interface (I/F) 256. The components described above are connected to each other by buses. The memory 252 and the auxiliary storage device 253 are storage devices and store programs and data used by the processor 251.

For example, the memory 252 is configured by a semiconductor memory, and is mainly used to store programs and data being executed. The processor 251 executes various processes according to programs stored in the memory 252. Various functional units (see FIG. 2A and the like) are implemented by the processor 251 operating according to the programs.

The auxiliary storage device 253 includes a mass storage device such as a hard disk drive or solid state drive, and is used to store programs and data for a long period of time. For example, the master data storage unit 213, the actual data accumulation unit 214, the actual process model accumulation unit 215, the master process model accumulation unit 216, and the synthetic process model accumulation unit 217 are implemented on the storage area of the auxiliary storage device 253.

The processor 251 can be configured with a single processing unit or a plurality of processing units, and can include single or a plurality of arithmetic units or a plurality of processing cores. The processor 251 may be implemented as one or more central processing units, microprocessors, microcomputers, microcontrollers, digital signal processors, state machines, logic circuits, graphics processing devices, chip-on-systems, and/or any device that manipulates signals based on control instructions.

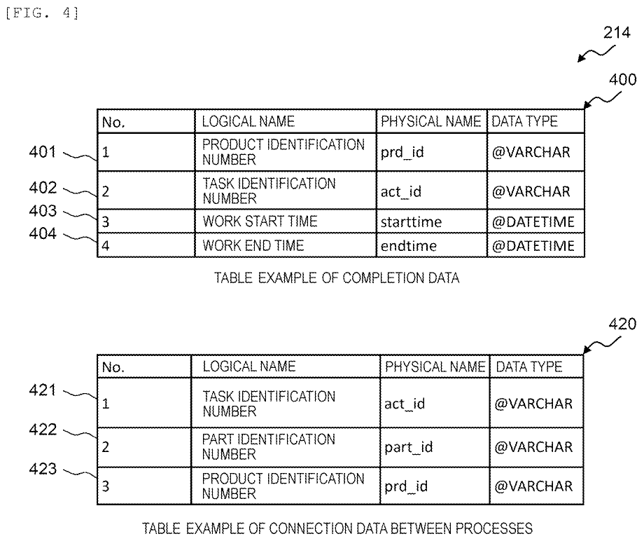

Programs and data stored in the auxiliary storage device 253 are loaded into the memory 252 at startup or when necessary, and various processes of the computer system 250 are executed by the processor 251 executing the programs. Therefore, in the following description, the process executed by the process model management unit 211 and the information collection unit 212, for example, is a process executed by the processor 251 according to the program, controlling each unit in the computer system 250 as necessary. The same applies to the process executed by each unit in the process model management unit 211, which will be described below with reference to FIG. 3.

The input device 255 is a hardware device for a user to input instructions, information, and the like. The output device 254 is a hardware device for presenting various input and output images, such as a display device or a printing device. The communication I/F 256 is an interface for connection with a network.

Note that the computer system 250 may include two or more processors 251. The functions of the system of the present embodiment can be implemented in a plurality of computer systems 250. Here, a plurality of computer systems 250 communicate via a network. For example, some of the plurality of functions of the system of the present embodiment may be embedded in one computer system 250, and the other functions may be embedded in another computer system.

FIG. 3 is a block diagram showing an example of a configuration of the process model management unit 211 according to an embodiment of the present invention.

The process model management unit 211 includes a master process model generation unit 301, a master process model difference detection unit 302, an actual process model generation unit 303, an actual process model difference detection unit 304, an actual process model-master process model difference detection unit 305, a synthetic process model generation unit 306, and a synthetic process model difference detection unit 307.

The master process model generation unit 301 generates a master process model based on the master data stored in the master data storage unit 213 and stores the generated model in the master process model accumulation unit 216. This corresponds to step 101 in FIG. 1. Likewise, the process in each unit will be described in association with the steps in FIG. 1.

The master process model difference detection unit 302 detects a difference between the newly generated master process model and the previously generated master process model accumulated in the master process model accumulation unit 216, and transmits the result to the master data management terminal 219 (step 102).

The actual process model generation unit 303 generates an actual process model based on the actual data accumulated in the actual data accumulation unit 214 and stores the generated model in the actual process model accumulation unit 215 (step 103). The actual process model difference detection unit 304 detects a difference between the newly generated actual process model and the previously generated actual process model accumulated in the actual process model accumulation unit 215, and transmits the result to the manufacturing site management terminal 231 (step 104).

The actual process model-master process model difference detection unit 305 detects a difference between the actual process model accumulated in the actual process model accumulation unit 215 and the master process model accumulated in the master process model accumulation unit 216 (step 105). The synthetic process model generation unit 306 generates a synthetic process model based on the difference detected in step 105, and stores the generated model in the synthetic process model accumulation unit 217 (step 106). The synthetic process model difference detection unit 307 detects a difference between the newly generated synthetic process model and the previously generated synthetic process model accumulated in the synthetic process model accumulation unit 217, and transmits the result to the process model management terminal 221 (step 107).

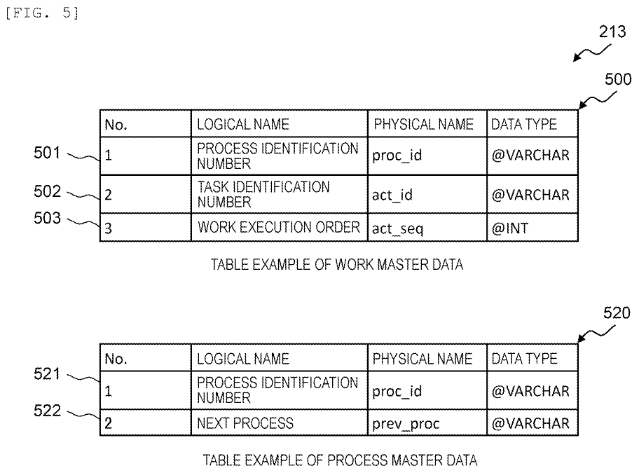

FIG. 4 is an explanatory diagram showing an example of data accumulated in the actual data accumulation unit 214 of the process model management system 200 according to an embodiment of the present invention.

The actual data accumulation unit 214 shown in FIG. 4 accumulates completion data 400 and inter-process connection data 420 as the actual data. For example, the completion data 400 is data in a table format including a plurality of records, and each record corresponds to one task actually performed. Each record includes a product identification number 401, a task identification number 402, work start time 403 and work end time 404. A logical name (for example, “product identification number” and the like), a physical name (for example, “prd_id” and the like), and a data type (for example, “VARCHAR” (variable length character string), “DATETIME” (date and time) and the like) of each item are defined.

For example, the inter-process connection data 420 is data in a table format including a plurality of records, and each record corresponds to a single transfer actually performed between processes (for example, a product completed with a task of one process is put into another process). Each record includes a task identification number 421, a part identification number 422, and a product identification number 423. The logical name, the physical name and the data type of each item are defined.

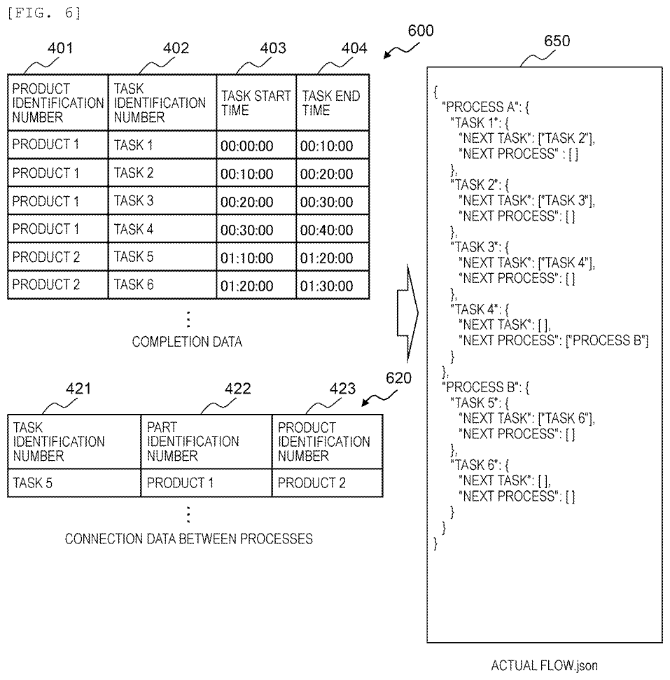

FIG. 5 is an explanatory diagram showing an example of data accumulated in the master data storage unit 213 of the process model management system 200 according to an embodiment of the present invention.

Work master data 500 and process master data 520 are accumulated as the master data in the master data storage unit 213 shown in FIG. 5. For example, the work master data 500 is data in a table format including a plurality of records, and each record corresponds to one task included in one process. Each record includes a process identification number 501, a task identification number 502, and a task execution order 503. The logical name, the physical name and the data type of each item are defined.

For example, the process master data 520 is data in a table format including a plurality of records, and each record indicates relationship between processes. Each record includes a process identification number 521 and a next process 522. The logical name, the physical name and the data type of each item are defined.

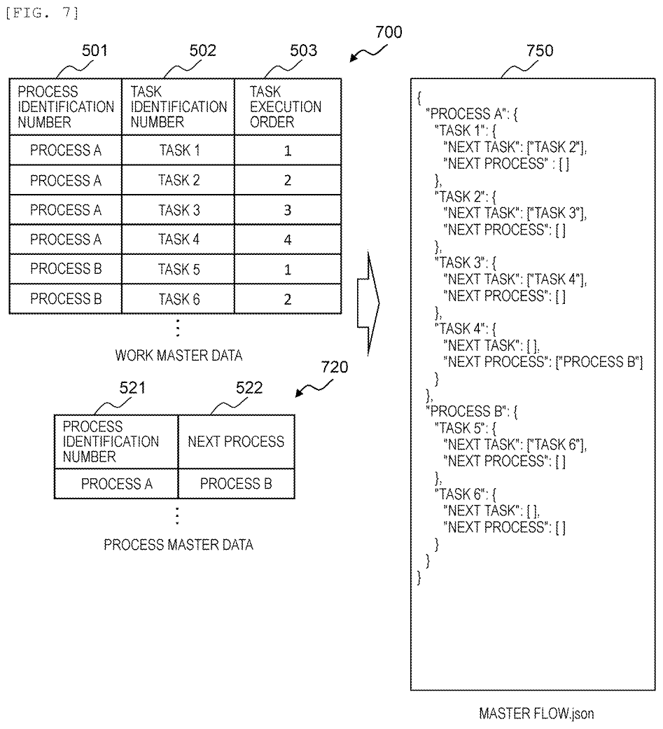

FIG. 6 is an explanatory diagram showing an example of a process in which the process model management system 200 according to an embodiment of the present invention generates an actual process model based on actual data.

Referring to FIG. 6, an example of a process executed by the actual process model generation unit 303 in step 103 of FIG. 1 will be described.

Completion data 600 shown in FIG. 6 shows detailed examples of the values of each item of the completion data 400 shown in FIG. 4. The example shows that “task 1” to “task 4” are executed sequentially for “product 1”, and then “task 5” and “task 6” are executed sequentially for “product 2”. Meanwhile, inter-process connection data 620 shown in FIG. 6 shows a detailed example of the values of each item of the inter-process connection data 420 shown in FIG. 4. The example shows that “product 1” is put into “task 5” as a part to be assembled into “product 2”.

The actual process model generation unit 303 generates an actual process model based on the actual data. Specifically, the actual process model generation unit 303 recognizes “task 1” to “task 4” that are executed sequentially for “product 1” as one process (for example, “process A”), and recognizes “task 5” to “task 6” that are executed sequentially for “product 2” as another process (for example, “process B”), based on the actual data described above. Then, the actual process model generation unit 303 recognizes that “product 1” as a result product of “process A” is put into “task 5” of “process B” as a part to be assembled into “product 2”.

An actual process model 650 shown in FIG. 6 is the process model recognized by the actual process model generation unit 303 based on the task data as described above and output as data in JSON (JavaScript Object Notation, JavaScript is a registered trademark) format. The actual process model 650 includes information indicating that “process A” includes “task 1”, “task 2”, “task 3” and “task 4”, “task 2” is executed after “task 1”, “task 3” is executed after “task 2”, and “task 4” is executed after “task 3”, “process B” is executed after “task 4”, “process B” includes “task 5” and “task 6”, and “task 6” is executed after “task 5”.

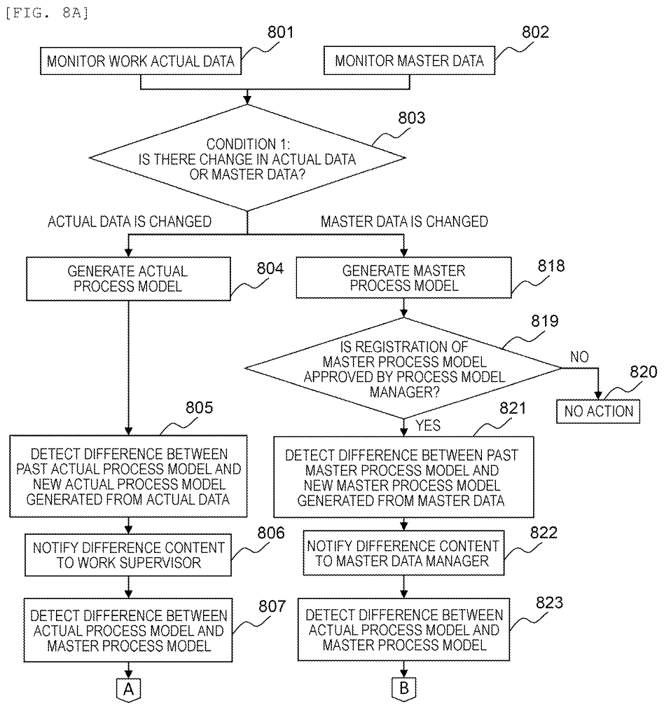

FIG. 7 is an explanatory diagram showing an example of a process in which the process model management system 200 according to an embodiment of the present invention generates a master process model based on the master data.

Referring to FIG. 7, an example of a process executed by the master process model generation unit 301 in step 101 of FIG. 1 will be described.

Work master data 700 shown in FIG. 7 shows detailed examples of the values of each item of the work master data 500 shown in FIG. 5. The example shows that “process A” includes “task 1” to “task 4” that are executed sequentially, and that “process B” includes “task 5” and “task 6” that are executed sequentially. Meanwhile, process master data 720 shown in FIG. 7 shows detailed examples of the values of each item of the process master data 520 shown in FIG. 5. The example shows that “process B” is executed after “process A”.

The master process model generation unit 301 generates a master process model based on the master data described above. A master process model 750 shown in FIG. 7 is the process model recognized by the master process model generation unit 301 based on the work master data 700 and the process master data 720 and output as data in JSON format. The master process model 750 includes information indicating that “process A” includes “task 1”, “task 2”, “task 3” and “task 4”, “task 2” is executed after “task 1”, “task 3” is executed after “task 2”, and “task 4” is executed after “task 3”, “process B” is executed after “task 4”, “process B” includes “task 5” and “task 6”, and “task 6” is executed after “task 5”.

In the examples of FIGS. 6 and 7 described above, the actual process model 650 generated by the actual process model generation unit 303 and the master process model 750 generated by the master process model generation unit 301 are the same as each other. Here, in step 105 of FIG. 1, the actual process model-master process model difference detection unit 305 detects no difference between the two models.

On the other hand, for example, when the manufacturing site supervisor changes the manufacturing process based on the actual condition of the manufacturing site, the actual data acquired therefrom changes, and the actual process model also changes accordingly. Alternatively, when the master data manager changes the master data for a purpose such as improving the efficiency of the manufacturing site, the master process model also changes accordingly. Here, the difference between the two models is detected.

Note that in FIGS. 6 and 7, the actual process model 650 and the master process model 750 in JSON format are generated. Although it would be desirable that formats of the two models are the same as each other to detect the difference between the two models, the JSON format does not have to be used, and any other format can be adopted.

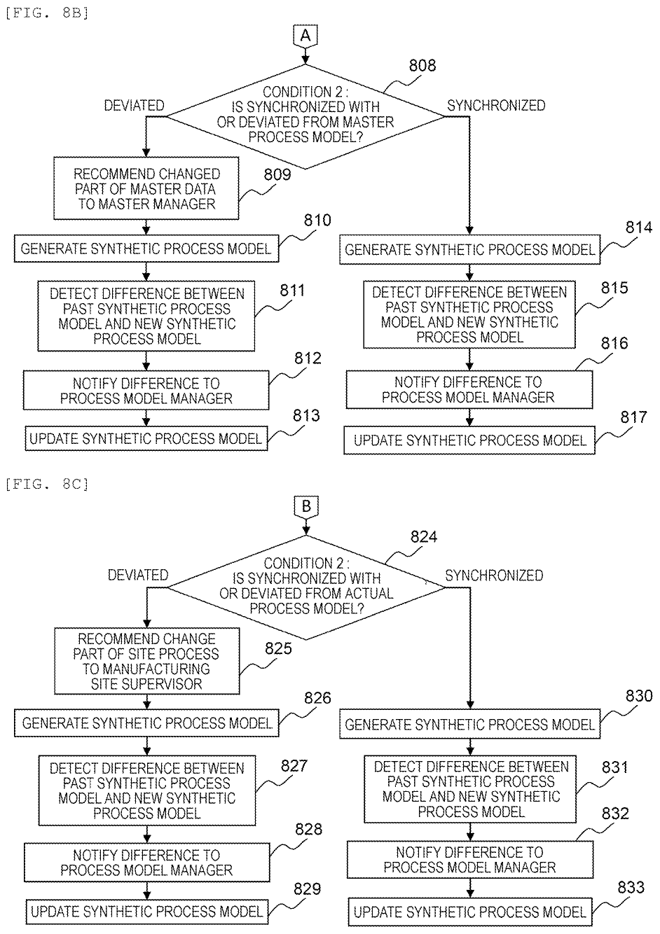

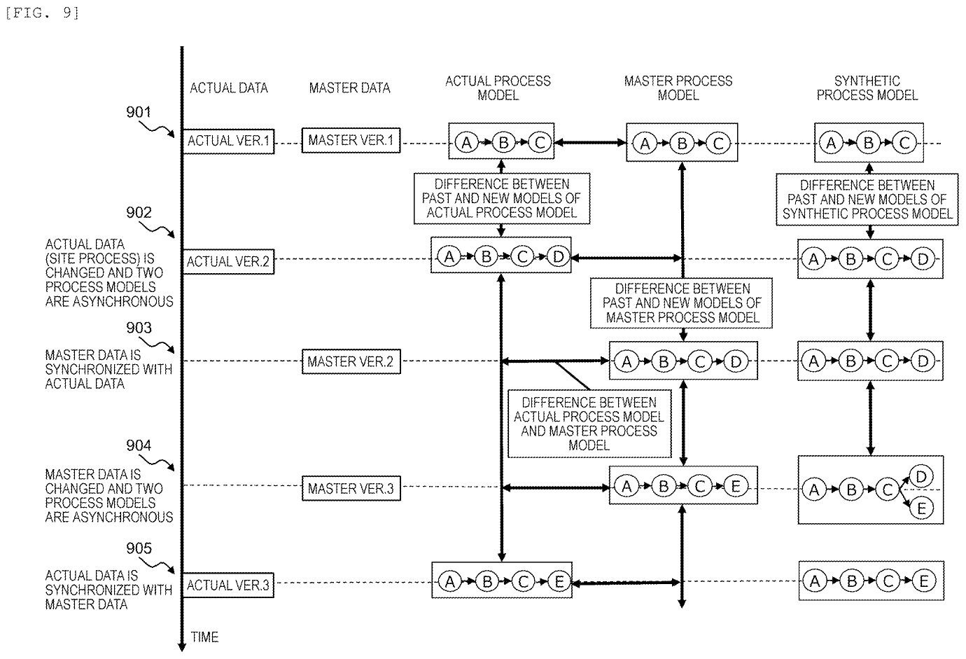

FIGS. 8A to 8C are flowcharts showing an example of a process executed by the process model management unit 211 of the process model management system 200 according to an embodiment of the present invention.

When the process shown in FIGS. 8A to 8C is started, the actual process model generation unit 303 generates an actual process model based on the actual data accumulated in the actual data accumulation unit 214 in advance, and the generated actual process model is stored in the actual process model accumulation unit 215. Likewise, the master process model generation unit 301 generates a master process model based on the master data stored in the master data storage unit 213 in advance, and the generated master process model is stored in the master process model accumulation unit 216. The synthetic process model generation unit 306 also generates a synthetic process model, and the generated synthetic process model is stored in the synthetic process model accumulation unit 217.

The actual process model generation unit 303 monitors the actual data (step 801). Meanwhile, the master process model generation unit 301 monitors the master data (step 802). Then, the actual process model generation unit 303 and the master process model generation unit 301 determine whether there is a change in the actual data and the master data, respectively (step 803).

For example, when the actual data generated by the work actual data generation device 232 is newly collected by the information collection unit 212 and stored in the actual data accumulation unit 214, the actual process model generation unit 303 monitors the actual data newly stored therein. Then, when the newly stored actual data is different from the actual data accumulated in the actual data accumulation unit 214 in advance, it may be determined that the actual data is changed.

Likewise, when the master data newly generated by the master data management terminal 219 is stored in the master data storage unit 213, the master process model generation unit 301 monitors the master data newly stored therein. Then, when the newly stored master data is different from the master data stored in the master data storage unit 213 in advance, it may be determined that the master data is changed.

When it is determined that the actual data is changed, the actual process model generation unit 303 generates an actual process model based on the changed actual data and stores the generated model in the actual process model accumulation unit 215 (step 804). Then, the actual process model difference detection unit 304 detects a difference between the past actual process model accumulated in the actual process model accumulation unit 215 and the newly generated actual process model (step 805), and notifies the manufacturing site management terminal 231 of the content of the detected difference (step 806). For example, even when a process change unintended by the supervisor for the manufacturing site occurs due to a machine failure at the manufacturing site and the like, for example, the change can be known based on the notification in step 806.

Next, the actual process model-master process model difference detection unit 305 detects a difference between the newly generated actual process model and the master process model (step 807). The actual process model-master process model difference detection unit 305 determines whether the newly generated actual process model is synchronized with or deviates from the master process model based on the detected difference (step 808). Here, the fact that the actual process model is synchronized with the master process model means that the actual process model matches the master process model. The same applies to “synchronization” in the following description.

For example, when the past actual process model compared in step 805 matches the master process model and the newly generated actual process model does not match the master process model, it is determined that the newly generated actual process model deviates from the master process model. Meanwhile, when the past actual process model compared in step 805 does not match the master process model and the newly generated actual process model matches the master process model, it is determined that the newly generated actual process model is synchronized with the master process model.

When it is determined that the newly generated actual process model deviates from the master process model, the actual process model-master process model difference detection unit 305 recommends a part to change in the master data to the master data manager 110 (step 809). For example, with respect to the difference between the actual process model and the master process model, it may be recommended to change the master process model to eliminate the difference.

Next, the synthetic process model generation unit 306 generates a synthetic process model by synthesizing the newly generated actual process model and the master process model (step 810). For example, the synthetic process model generation unit 306 generates a synthetic process model such that each process includes both a task included in the actual process model and a task included in the master process model.

The synthetic process model generated here is a candidate for replacing the synthetic process model stored up to then. The synthetic process model stored up to then is maintained until the synthetic process model is updated in step 813 which will be described below. The same applies to steps 814 to 817, 826 to 829, and 830 to 833 which will be described below.

Next, the synthetic process model difference detection unit 307 detects a difference between the newly generated synthetic process model and the past synthetic process model accumulated in the synthetic process model accumulation unit 217 (step 811), and notifies the process model manager 130 of the detected difference (step 812). The notification may include information indicating the synthetic process model being changed and a changed part thereof. Then, the synthetic process model difference detection unit 307 stores the newly generated synthetic process model in the synthetic process model accumulation unit 217 to update the synthetic process model (step 813).

In step 808, when it is determined that the newly generated actual process model is synchronized with the master process model, the synthetic process model generation unit 306 generates a synthetic process model by synthesizing the actual process model and the newly generated master process model (step 814). For example, the model can be generated in the same manner as in step 810.

Next, the synthetic process model difference detection unit 307 detects a difference between the newly generated synthetic process model and the synthetic process model previously accumulated in the synthetic process model accumulation unit 217 (step 815), and notifies the process model manager 130 of the detected difference (step 816). The notification may include information indicating the synthetic process model being changed and a changed part thereof, and may also include information indicating that the actual process model is changed and thus synchronized with the master process model. Then, the synthetic process model difference detection unit 307 stores the newly generated synthetic process model in the synthetic process model accumulation unit 217 to update the synthetic process model (step 817).

In step 803, when it is determined that the master data is changed, the master process model generation unit 301 generates a master process model based on the changed master data and stores the generated model in the master process model accumulation unit 216 (step 818). Then, the master process model difference detection unit 302 determines whether the process model manager 130 approved the registration of the master process model (step 819). When the registration of the master process model is not approved, no action is performed (step 820). Specifically, the master process model difference detection unit 302 may wait until the registration of the master process model is approved, or the process may return to steps 801 and 802.

When the registration of the master process model is approved, the master process model difference detection unit 302 detects a difference between the past master process model accumulated in the master process model accumulation unit 216 and the newly generated master process model (step 821), and notifies the master data management terminal 219 of the content of the detected difference (step 822).

Next, the actual process model-master process model difference detection unit 305 detects a difference between the actual process model and the newly generated master process model (step 823). The actual process model-master process model difference detection unit 305 determines, based on the detected difference, whether the newly generated master process model is synchronized with or deviates from the actual process model (step 824).

For example, when the past master process model compared in step 821 matches the actual process model and the newly generated master process model does not match the actual process model, it is determined that the newly generated master process model deviates from the actual process model. Meanwhile, when the past master process model compared in step 821 does not match the actual process model and the newly generated master process model matches the actual process model, it is determined that the newly created master process model is synchronized with the actual process model.

When it is determined that the newly generated master process model deviates from the actual process model, the actual process model-master process model difference detection unit 305 recommends a part to change in the site process to the manufacturing site supervisor (step 825). For example, with respect to the difference between the actual process model and the master process model, it may be recommended to change the site process to eliminate the difference. For example, the recommendation is transmitted to the manufacturing site management terminal 231.

Next, the synthetic process model generation unit 306 generates a synthetic process model by synthesizing the newly generated master process model and the actual process model (step 826). For example, the model can be generated in the same manner as in step 810.

Next, the synthetic process model difference detection unit 307 detects a difference between the newly generated synthetic process model and the past synthetic process model accumulated in the synthetic process model accumulation unit 217 (step 826), and notifies the process model manager 130 of the detected difference (step 828). The notification may include information indicating the synthetic process model being changed and a changed part thereof. Then, the synthetic process model difference detection unit 307 stores the newly generated synthetic process model in the synthetic process model accumulation unit 217 to update the synthetic process model (step 829).

In step 824, when it is determined that the newly generated master process model is synchronized with the actual process model, the synthetic process model generation unit 306 generates a synthetic process model by synthesizing the master process model and the newly generated actual process model (step 830). For example, the model can be generated in the same manner as in step 810.

Next, the synthetic process model difference detection unit 307 detects a difference between the newly generated synthetic process model and the synthetic process model previously accumulated in the synthetic process model accumulation unit 217 (step 831), and notifies the process model manager 130 of the detected difference (step 832). The notification may include information indicating the synthetic process model being changed and a changed part thereof, and may also include information indicating that the newly generated master process model is synchronized with the actual process model. Then, the synthetic process model difference detection unit 307 stores the newly generated synthetic process model in the synthetic process model accumulation unit 217 to update the synthetic process model (step 833).

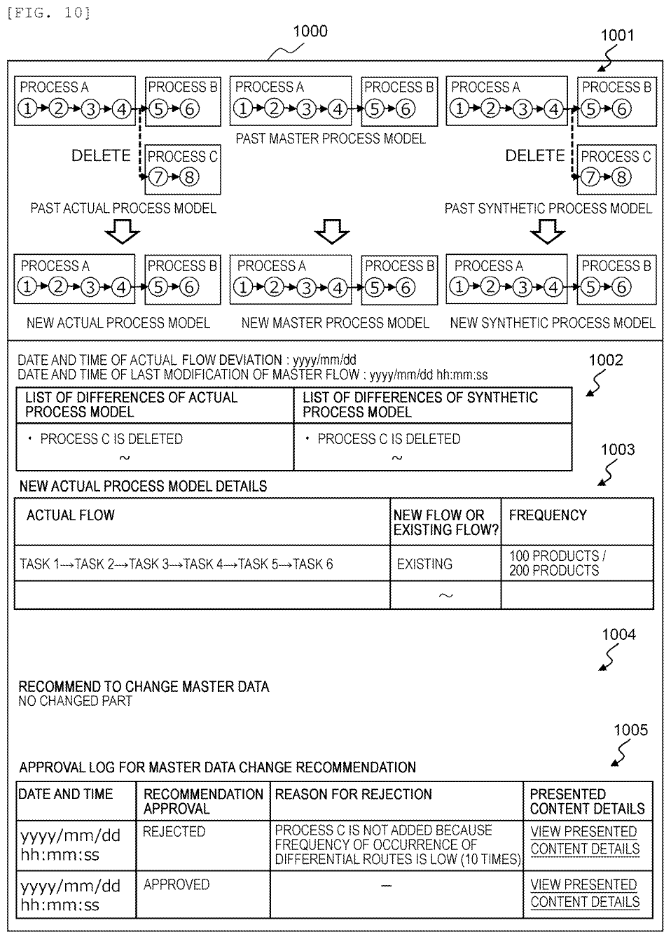

A detailed example of the process shown in FIGS. 8A to 8C will be described with reference to FIGS. 8A to 8C and FIG. 9.

FIG. 9 is an explanatory diagram showing an example of a process executed by the process model management unit 211 of the process model management system 200 according to an embodiment of the present invention.

At first time point 901, the version of the actual data is “actual Ver. 1”, and the actual process model generated based on the same shows a process in which “task A”, “task B”, and “task C” are executed sequentially. Meanwhile, the version of the master data is “master Ver. 1”, and the master process model generated based on the same shows a process in which “task A”, “task B”, and “task C” are executed sequentially. Here, the actual process model and the master process model match each other (that is, there is no difference between the models), and the synthetic process model shows, similarly to the above models, a process in which “task A”, “task B”, and “task C” are executed sequentially.

In FIG. 9, “task A”, “task B”, “task C”, and the like are indicated by circled symbols with “A”, “B”, “C”, and the like marked therein, and rectangles enclosing them indicate processes including the tasks.

Next, at time point 902, the actual data is changed to a version of “actual Ver. 2”. For example, such change can occur when the site supervisor changes the manufacturing process for a purpose such as improving the efficiency of the manufacturing line. In step 803, it is determined that the actual data is changed. In step 804, an actual process model is generated that shows a process in which “task A”, “task B”, “task C”, and “task D” are executed sequentially.

Here, a difference of the actual process model is detected in step 805, and notification in step 806 is performed. In step 807, “task D” added after “task C” is detected as a difference between the actual process model and the master process model.

Here, in step 808, it is determined that the actual process model deviates from the master process model. In step 809, the master data manager 110 is recommended to add “task D” after “task C” in the master data.

In step 810, a process including “task A”, “task B”, “task C” and “task D” including all of “task A”, “task B”, “task C” and “task D” which are executed sequentially and “task A”, “task B” and “task C” which are executed sequentially is generated as a synthetic process model. In step 811, it is detected that “task D” is added as a difference, the difference is notified in step 812, and the synthetic process model is updated to the newly generated one described above in step 813.

Next, at time point 903, the master data is changed to “master Ver. 2”. The change may be the result of change made by the master data manager in response to the recommendations of step 809 at the time point 902 described above, for example. In step 803, it is determined that the master data is changed. In step 818, a master process model is generated that shows a process in which “task A”, “task B”, “task C”, and “task D” are executed sequentially.

Here, a difference of the master process model is detected in step 821 and notification in step 822 is performed. In the example, the master process model is changed such that the master process model matches the actual process model. Therefore, it is detected that there is no difference between the actual process model and the master process model in step 823, and it is determined that the master process model is synchronized with the actual process model in step 824.

In step 830, a synthetic process model is generated that shows a process in which “task A”, “task B”, “task C”, and “task D” are executed sequentially. Since the synthetic process model is the same as the synthetic process model generated at the time point 902, it is detected that there is no difference in step 831 and notified in step 832. In step 833, the synthetic process model is updated to the newly generated synthetic process model described above.

Next, at time point 904, the master data is changed to “master Ver. 3”. For example, the change may occur when the master data manager attempts to change the manufacturing process for a purpose such as improving the efficiency of the manufacturing line. In step 803, it is determined that the master data is changed. In step 818, a master process model is generated that shows a process in which “task A”, “task B”, “task C”, and “task E” are executed sequentially.

Here, a difference of the master process model is detected in step 821 and notification in step 822 is performed. In step 823, it is detected, as a difference between the actual process model and the master process model, that “task D” to be executed after “task C” in the actual process model is replaced by “task E” to be executed after “task C” in the master process model.

Here, in step 824, it is determined that the master process model deviates from the actual process model. In step 825, it is recommended for the manufacturing site supervisor to execute “task E” instead of “task D” after “task C” of the master data.

In step 826, a process including “task A”, “task B”, “task C”, “task D” and “task E” including all of “task A”, “task B”, “task C” and “task D” which are executed sequentially and “task A”, “task B”, “task C” and “task E” which are executed sequentially, is generated as a synthetic process model.

The generation of the synthetic process model at the time point 904 will be described in detail below. As described above, at the time point 904, the actual process model shows a process including “task A”, “task B” (to be executed after “task A”), “task C” (to be executed after “task B”), and “task D” (to be executed after “task C”). On the other hand, the master process model is updated to show a process including “task A”, “task B” (to be executed after “task A”), “task C” (to be executed after “task B”), and “task E” (to be executed after “task C”).

Here, a synthetic process model is generated that shows a process including all the tasks described above. That is, the synthetic process model is updated to show a process including “task A”, “task B” (to be executed after “task A”), “task C” (to be executed after “task B”), “task D” (to be executed after “task C”), and “task E” (to be executed after “task C”). That is, in the synthetic process model generated at the time point 904, the task following “task C” is branched into “task D” and “task E”.

It is detected that “task E” to be executed after “task C” is added as a difference in step 827, the difference is notified in step 828, and the synthetic process model is updated to the newly generated synthetic process model described above in step 829.

Next, at time point 905, the actual data is changed to “actual Ver. 3”. For example, the change may be the result of the manufacturing site supervisor changing “task D” to be executed after “task C” to “task E” according to the recommendation of step 825 at the time point 904 described above. In step 803, it is determined that the actual data is changed. In step 804, an actual process model is generated that shows a process in which “task A”, “task B”, “task C”, and “task E” are executed sequentially.

Here, a difference of the actual process model is detected at step 805, and notification at step 806 is performed. In step 807, it is detected that there is no difference between the actual process model and the master process model, and in step 808, it is determined that the actual process model is synchronized with the master process model.

In step 814, a process including “task A”, “task B”, “task C”, and “task E” which are executed sequentially is generated as a synthetic process model. It is detected that “task E” to be executed after “task C” is deleted as a difference in step 815, the difference is notified in step 816, and the synthetic process model is updated to the newly generated synthetic process model described above in step 817.

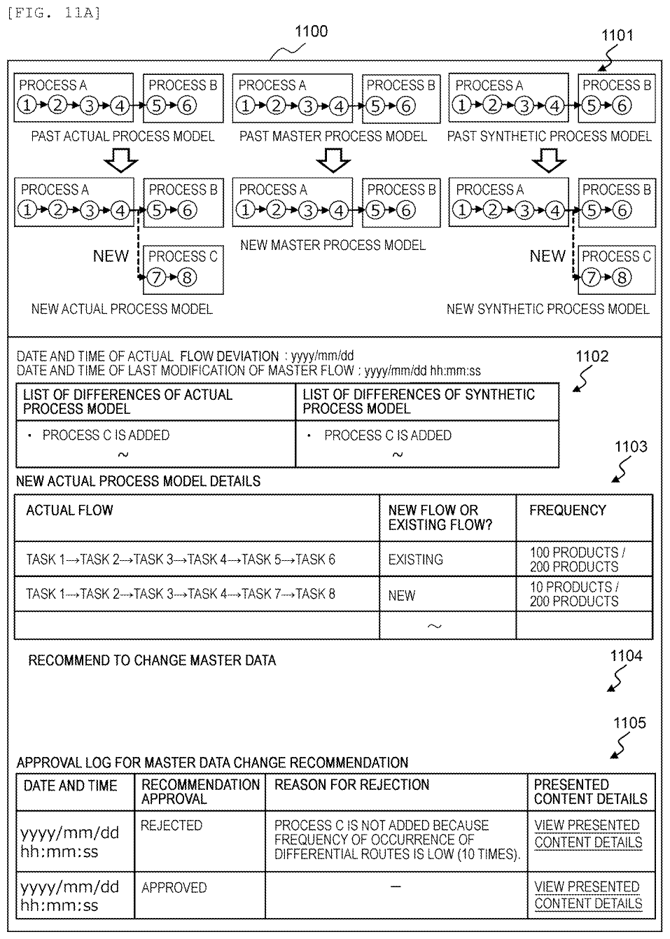

Next, examples of a display screen of the process model management system 200 will be described with reference to FIGS. 10 to 13.

FIG. 10 is an explanatory diagram showing an example of a screen displayed when the actual process model is synchronized with the master process model by changing the actual process model in the process model management system 200 according to an embodiment of the present invention.

A display screen 1000 shown in FIG. 10 includes a process model display unit 1001, a difference display unit 1002, a process model detail display unit 1003, a recommendation display unit 1004, and a recommendation approval log display unit 1005.

The process model display unit 1001 displays a set of a past model and a new model for each of the actual process model, the master process model, and the synthetic process model. In the process model display unit 1001, “task 1” to “task 8” are displayed by circled symbols having digits “1” to “8” marked therein, respectively. A process including a plurality of tasks is displayed by a rectangle enclosing the symbols of the tasks.

In the example of FIG. 10, the past actual process model and the past master process model do not match each other. The past actual process model is configured with “process A”, “process B” and “process C”. The “process A” includes “task 1” to “task 4” that are executed sequentially. The “process B” includes “task 5” and “task 6” that are executed sequentially using the result product of “task 4” as a part. The “process C” includes “task 7” and “task 8” that are executed sequentially using the result product of “task 4” as a part. Meanwhile, the past master process model is configured with “process A” and “process B” like the above, and does not include “process C”. The past synthetic process model is similar to the past actual process model.

The example of FIG. 10 shows that “process C” is deleted from the actual process model. As a result, the new actual process model is configured with “process A” and “process B” and does not include “process C”. Meanwhile, the new master process model is unchanged from the past master process model. Thus, the new actual process model is synchronized with the new master process model, and the new synthetic process model is changed to be like the two models.

The difference display unit 1002 displays information on the detected difference between the process models. In the example of FIG. 10, when the actual process model deviates from the master process model, the difference display unit 1002 displays the date and time when the deviation occurred and the date and time when the master process model was last updated.

The difference display unit 1002 displays a list of differences detected in the actual process model and a list of differences detected in the synthetic process model. When the process model is updated as displayed in the process model display unit 1001, since it is detected that “process C” is deleted from the actual process model (step 805 in FIG. 8A), and it is also detected that “process C” is deleted from the synthetic process model (step 815 in FIG. 8B), information indicating the differences is displayed.

The process model detail display unit 1003 displays information indicating the details of the new actual process model. In the example of FIG. 10, a new actual process model displayed in the process model display unit 1001, that is, a task flow based on the actual performance of executing “task 1” to “task 6” sequentially is displayed. It is displayed that the new actual process model is also included in the past actual process model (that is, it is the existing model), and that manufacturing based on the task flow is performed with a frequency of 100 products per 200 products.

In general, at the manufacturing site, multiple types of products may be manufactured, and different matching processes may be applied for each type. Alternatively, even for products of the same type, there are cases where exceptional task is performed, such as low-frequency sampling inspections such as 1 out of 100 products, or process performed when there is an abnormality in manufacturing. The display of frequency in the process model detail display unit 1003 is to display such a frequency.

The recommendation display unit 1004 displays a recommendation of a part to change in the master data to the master data manager 110 (step 809 in FIG. 8B) or a recommendation of a part to change in the site process to the manufacturing site supervisor (step 825 in FIG. 8C). In the example of FIG. 10, neither steps 809 nor 825 are executed and no recommendations are displayed, because the actual process model is synchronized with the master process model as a result of the change in the actual process model.

The recommendation approval log display unit 1005 displays information on whether a recommendation made in the past is approved or rejected (that is, whether a change is made according to the recommendation). Specifically, whether the past recommendation is approved or rejected, the date and time when the approval or rejection was made, and the reason in the case of rejection, and the like are displayed. In the recommendation approval log display unit 1005, a link may be attached for displaying the content of recommendations presented in the past. When the link is operated, the presented content of recommendation is displayed.

In the example of FIG. 10, the past recommendations and the history of responses thereto are displayed, showing that “process C” was added to the actual process model based on the actual data, and it was recommended to add “process C” to the master process model as well based on the addition to the actual process model, but the addition of “process C” to the master process model was rejected because the frequency of occurrence of the route from “process A” to “process C” was low, and as a result, “process C” was deleted from the actual process model and the synthetic process model.

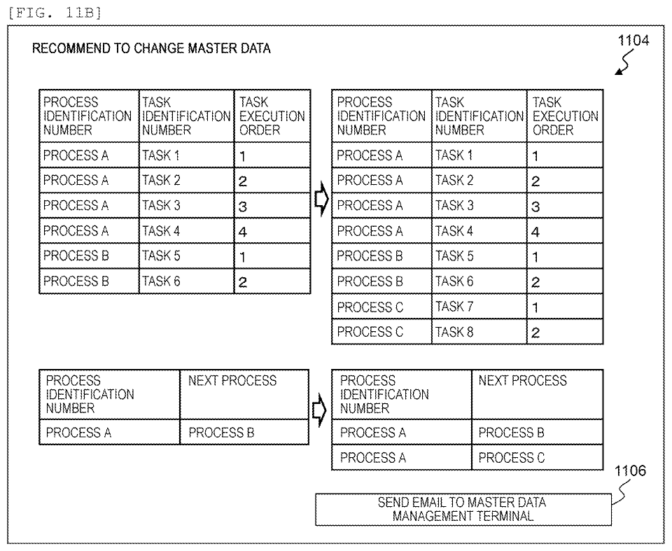

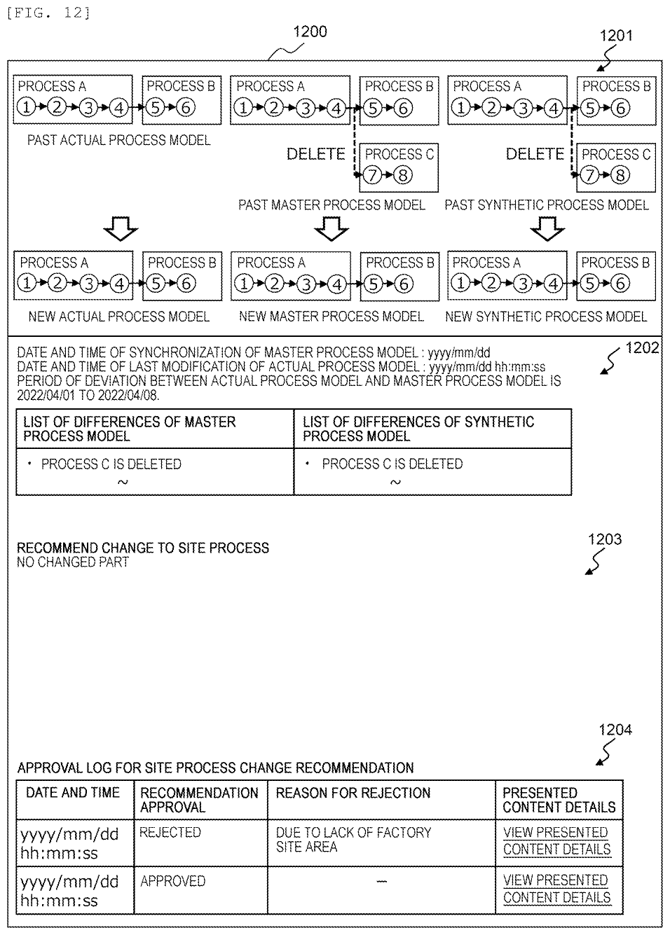

FIGS. 11A and 11B are explanatory diagrams showing an example of a screen displayed when the actual process model deviates from the master process model by changing the actual process model in the process model management system 200 according to an embodiment of the present invention.

A display screen 1100 shown in FIG. 11A includes a process model display unit 1101, a difference display unit 1102, a process model detail display unit 1103, a recommendation display unit 1104, and a recommendation approval log display unit 1105. The units correspond to the process model display unit 1001, the difference display unit 1002, the process model detail display unit 1003, the recommendation display unit 1004, and the recommendation approval log display unit 1005 of the display screen 1000 shown in FIG. 10, respectively, but the respective display contents are different from those shown in FIG. 10. The differences will be explained below.

As shown in the process model display unit 1101, in the example of FIG. 11A, the past actual process model, the past master process model, and the past synthetic process model match, and all of the models are configured with “process A” and “process B”.

The example of FIG. 11A shows that “process C” is added to the actual process model. As a result, the new actual process model includes “process A”, “process B” and “process C”. Meanwhile, the new master process model is unchanged from the past master process model. Therefore, the new actual process model deviates from the new master process model, and the new synthetic process model is changed to include all of “process A”, “process B”, and “process C”.

The difference display unit 1102 displays a list of differences detected in the actual process model and a list of differences detected in the synthetic process model. When the process model is updated as displayed in the process model display unit 1101, since it is detected that “process C” is added to the actual process model (step 805 in FIG. 8A), and it is also detected that “process C” is added to the synthetic process model (step 811 in FIG. 8B), information indicating the differences is displayed.

The process model detail display unit 1103 displays the new actual process model displayed in the process model display unit 1001, that is, displays a task flow based on the actual performance in which “task 1”, “task 2”, “task 3”, “task 4”, “task 5”, and “task 6” are executed sequentially, and a task flow based on the actual performance in which “task 1”, “task 2”, “task 3”, “task 4”, “task 7”, and “task 8” are executed sequentially.

Information is displayed, indicating that the former of the above is also included in past actual process models (that is, the former is the existing model), but the latter is not included (that is, the latter is a new model). Information is displayed, indicating that the manufacturing based on the former task flow was performed with a frequency of 100 out of 200 products, while the manufacturing based on the latter task flow was performed with a frequency of 10 products out of 200.

The recommendation display unit 1104 displays a recommendation of a part to change in the master data to the master data manager 110 (step 809 in FIG. 8B) or a recommendation of a part to change in the site process to the manufacturing site supervisor (step 825 in FIG. 8C). In the example of FIG. 11A, as a result of the change of the actual process model, the actual process model deviates from the master process model, so step 809 is executed, and a recommendation to change the master data to eliminate the deviation is displayed.

For example, as shown in FIG. 11B, the recommendation display unit 1104 may display information for recommending to add “process C” including “task 7” and “task 8” executed sequentially after “process A”, to the master process model including “process A” including “task 1” to “task 4” executed sequentially and then “process B” including “task 5” and “task 6” executed sequentially.

The recommendation display unit 1104 may further include an email transmission button 1106. When the user operates the email transmission button 1106, the recommended information is transmitted to the master data management terminal 219.

The recommendation approval log display unit 1105 may display the same content as the recommendation approval log display unit 1005.

For example, when the task flow from “process A” to “process B” corresponds to a normal manufacturing process, if the task flow from “process A” to “process C” is an exceptional process such as a low-frequency sampling inspection, actual data corresponding to such exceptional task is generated as the task is actually performed. Then, the actual process model generation unit 303 generates an actual process model from “process A” to “process C” based on the actual data. Here, there appears a difference in frequency as shown in the process model detail display unit 1103.

The master data manager 110 may approve the master data change recommendation when determining that such exceptional task should also be reflected in the process model. Here, “process C” is added to the master process model, and the master process model is synchronized with the actual process model.

Meanwhile, the master data manager 110 can reject the master data change recommendation when determining that such exceptional task should not be reflected in the process model. Here, as shown in FIG. 10, “process C” is deleted from the actual process model, and the actual process model is synchronized with the master process model.

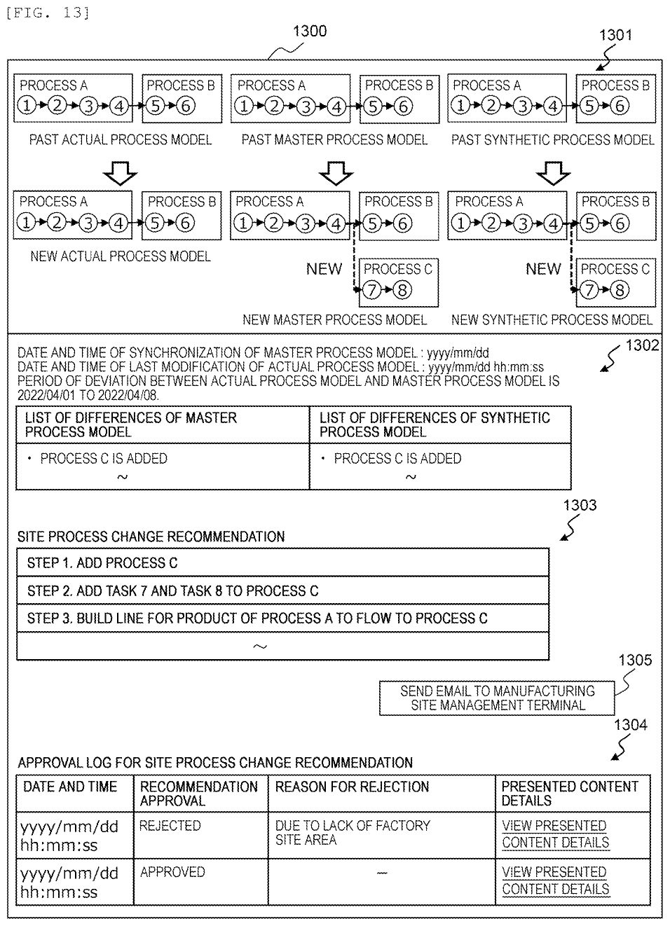

FIG. 12 is an explanatory diagram showing an example of a screen displayed when the master process model is synchronized with the actual process model by changing the master process model in the process model management system 200 according to an embodiment of the present invention.

A display screen 1200 shown in FIG. 12 includes a process model display unit 1201, a difference display unit 1202, a recommendation display unit 1203 and a recommendation approval log display unit 1204. The units correspond to the process model display unit 1001, the difference display unit 1002, the recommendation display unit 1004, and the recommendation approval log display unit 1005 of the display screen 1000 shown in FIG. 10, but the respective displayed contents are different from those shown in FIG. 10. The differences will be explained below.

As shown in the process model display unit 1201, in the example of FIG. 12, the past actual process model and the past master process model do not match each other. The past actual process model is configured with “process A” and “process B”. Meanwhile, the past master process model is configured with “process A”, “process B” and “process C”. The past synthetic process model is similar to the past master process model.

The example of FIG. 12 shows that “process C” is deleted from the master process model. As a result, the new master process model is configured with “process A” and “process B” and does not include “process C”. Meanwhile, the new actual process model is unchanged from the past actual process model. Thus, the new master process model is synchronized with the new actual process model, and the new synthetic process model is changed to be like the two models.

When the master process model is synchronized with the actual process model, the difference display unit 1202 displays the date and time when the model was synchronized, the date and time when the actual process model was last updated, and a period of time during which the actual process model and the master process model deviated from each other.

When the process model is updated as displayed in the process model display unit 1201, since it is detected that “process C” is deleted from the master process model (step 821 in FIG. 8A), and it is also detected that “process C” is deleted from the synthetic process model (step 831 in FIG. 8B), the difference display unit 1202 displays information indicating the difference.

In the example of FIG. 12, neither step 809 nor step 825 is executed and no recommendation is displayed on the recommendation display unit 1203, because the master process model is synchronized with the actual process model as a result of the change in the master process model.

In the example of FIG. 12, the recommendation approval log display unit 1204 displays the past recommendations and the history of responses thereto, showing that “process C” was added to the master process model based on the master data, and it was recommended to add “process C” to the actual process model as well based on the addition to the master process model, but the addition of “process C” to the actual process model was rejected due to lack of factory site area to add “process C”, and as a result, “process C” was deleted from the master process model and the synthetic process model.

FIG. 13 is an explanatory diagram showing an example of a screen displayed when the master process model deviates from the actual process model by changing the master process model in the process model management system 200 according to an embodiment of the present invention.

A display screen 1300 shown in FIG. 13 includes a process model display unit 1301, a difference display unit 1302, a recommendation display unit 1303 and a recommendation approval log display unit 1304. These correspond to the process model display unit 1201, the difference display unit 1202, the recommendation display unit 1203, and the recommendation approval log display unit 1204 of the display screen 1200 shown in FIG. 12, but the respective displayed contents are different from those shown in FIG. 12. The differences will be explained below.

As shown in the process model display unit 1301, in the example of FIG. 13, the past actual process model, the past master process model, and the past synthetic process model match, and all of the models are configured with “process A” and “process B”.

The example of FIG. 13 shows that “process C” is added to the master process model. As a result, the new master process model includes “process A”, “process B” and “process C”. Meanwhile, the new actual process model is unchanged from the past actual process model. Therefore, the new master process model deviates from the new actual process model, and the new synthetic process model is changed to include all of “process A”, “process B”, and “process C”.

When the process model is updated as displayed in the process model display unit 1301, since it is detected that “process C” is added to the master process model (step 821 in FIG. 8A), and it is also detected that “process C” is added to the synthetic process model (step 827 in FIG. 8B), the difference display unit 1302 displays information indicating the difference.

In the example of FIG. 13, as a result of the change of the master process model, the master process model deviates from the master process model, so step 825 is executed, and the recommendation display unit 1303 displays a recommendation to change the master data to eliminate the deviation.

For example, the recommendation display unit 1303 may display information that recommends adding “process C” to the site process, adding “task 7” and “task 8” to “process C”, and building a line that transfers completed products of “process A” to “process C”.

The recommendation display unit 1303 may further include an email transmission button 1305. When the user operates the email transmission button 1305, the recommended information is transmitted to the manufacturing site management terminal 231.

The recommendation approval log display unit 1304 may display the same content as the recommendation approval log display unit 1204.

For example, when the master data manager 110 adds “process C” to the master data for a purpose such as improving the efficiency of the manufacturing site, “process C” is added to the master process model and the synthetic process model, and a recommendation to add “process C” to the site process is transmitted to the manufacturing site supervisor.

The manufacturing site supervisor may approve the addition of “process C” and add “process C” to the site process. Here, when the task of “process C” is actually performed and the actual data of the result is acquired, “process C” is also added to the actual process model, and the actual process model is synchronized with the master process model.

Meanwhile, the manufacturing site supervisor can reject the recommendation to change the site process when determining that the addition of “process C” is not appropriate due to lack of the site area of the factory, for example. Here, as shown in FIG. 12, “process C” is deleted from the master process model, and the master process model is synchronized with the actual process model.

In the synthetic process model displayed in the process model display units 1001 to 1301 of FIGS. 10 to 13, the processes and tasks based only on the actual process model, the processes and tasks based only on the master process model, and the processes and tasks based on both the actual process model and the master process model may be respectively displayed in different modes (for example, with different shaped figures, or in different colors).

For example, in the past synthetic process models displayed in the process model display unit 1001, “task 1” to “task 4” of “process A” and “task 5” and “task 6” of “process B” are based on both the past actual process model and the past master process model. On the other hand, “task 7” and “task 8” of “process C” are based only on the past actual process model. Therefore, the tasks may be displayed in different modes.

Meanwhile, in the past synthetic process models displayed in the process model display unit 1201, “task 1” to “task 4” of “process A” and “task 5” and “task 6” of “process B” are based on both the past actual process model and the past master process model. On the other hand, “task 7” and “task 8” of “process C” are based only on the past master process model. Therefore, the tasks may be displayed in different modes.

As a result, the master data manager 110 or the manufacturing site supervisor who received the notification can easily check the data from which the task of each process is derived, such that the determination of whether to incorporate each process and task into the process model as they are or delete the process and task from the process model is supported.

According to the embodiments of the present invention described above, even when there is a deviation between the process at the manufacturing site and the master data, the speedy synchronization is supported, and appropriate data acquisition based on the process model that matches the manufacturing site is made possible, thereby improving productivity. For example, it is possible to quickly reflect changes in the process that occurred in the manufacturing site to the master data. It is possible to quickly notify the manufacturing site of changes in the master data. Even when unintended changes in the process, such as a machine failure, occur at the manufacturing site, the changes can be quickly detected.

The system of the embodiment of the present invention may be configured as follows.

(1) A process model management system including a processor (for example, the processor 251) and a storage device (for example, at least one of the memory 252 and the auxiliary storage device 253), in which the storage device is configured to store actual data (for example, data accumulated in the actual data accumulation unit 214) indicating actual performance of tasks executed at a manufacturing site, and master data (for example, data stored in the master data storage unit 213) including design information on the order of tasks to be executed, and the processor is configured to generate an actual process model including task execution order information based on the actual data (for example, step 804), generate a master process model including task execution order information based on the master data (for example, step 818), and generate a synthetic process model including both the task execution order information included in the actual process model and the task execution order information included in the master process model (for example, steps 810, 814, 826, and 830), when the actual data is changed, detect a difference between a past actual process model generated based on the actual data before change and a new actual process model generated based on the actual data after change (for example, step 805), when the master data is changed, detect a difference between the past master process model generated based on the master data before change and the new master process model generated based on the master data after change (for example, step 821), detect a difference between a past synthetic process model generated based on the actual process model and the master process model before the actual data and the master data are changed and a new synthetic process model generated based on the actual process model and the master process model after one of the actual data and the master data is changed (for example, steps 811, 815, 827, 831), and output a notification based on the detected difference (for example, steps 806, 809, 812, 816, 822, 825, 828, 832).

As a result, efficient process model management is supported based on whether the actual process model is changed, whether the master process model is changed, and whether the synthetic process model is changed.

(2) According to (1) described above, the processor is configured to output, as the notification to a supervisor for the manufacturing site, information indicating the content of the difference between the detected past actual process model and the new actual process model (for example, steps 805, 806).

Accordingly, the management of the manufacturing site process by the supervisor for the manufacturing site is supported. The supervisor for the manufacturing site can detect occurrence of unexpected process change.

(3) According to (2) described above, the processor is configured to determine whether the new actual process model deviates from the master process model or matches the master process model, based on the difference between the new actual process model and the master process model (for example, step 808), when the new actual process model deviates from the master process model, output, as the notification to the manager of the master data, information indicating content of the difference between the new actual process model and the master process model, and parts to change in the master data to match the changed actual data (for example, step 809), and when the new actual process model matches the master process model, output, as the notification to the manager of the process model, information indicating that the new actual process model matches the master process model (for example, step 816).

As a result, the deviation between the state of the manufacturing site and the master data is quickly checked, and information indicating the content of the deviation is provided, thereby supporting the elimination of the deviation.

(4) According to (3) described above, the processor is configured to, when the new actual process model deviates from the master process model, generate a new synthetic process model based on the new actual process model and the master process model, regardless of approval or rejection by the manager of the process model (for example, step 813).

Accordingly, the generation of a process model that matches the current state of the manufacturing site is supported.

(5) According to (1) described above, the processor is configured to output, as a notification to the manager of master data, information indicating the content of the difference between the detected past master process model and the new master process model (for example, steps 821, 822).

Accordingly, the management of the master data by the master data manager is supported.

(6) According to (5) described above, the processor is configured to determine whether the new master process model deviates from or matches the actual process model, based on the difference between the new master process model and the actual process model (for example, step 824), when the new master process model deviates from the actual process model, output, as the notification to the supervisor for the manufacturing site, information indicating the content of the difference between the new master process model and the actual process model and a part to change in the manufacturing process at the manufacturing site to match the changed master data (for example, step 825), and when the new master process model matches the actual process model, output, as a notification to the process model manager, information indicating that the new master process model matches the actual process model (for example, step 832).

As a result, the deviation between the state of the manufacturing site and the master data is quickly checked, and information indicating the content of the deviation is provided, thereby supporting the elimination of the deviation.

(7) According to (6) described above, the processor is configured to, when the new master process model deviates from the actual process model and the approval of the process model manager is obtained (for example, step 819: Yes), generate a new synthetic process model based on the new master process model and the actual process model (step 829), and when the new master process model deviates from the actual process model but the approval of the manager of the process model is not obtained (for example, step 819: No), not generate a synthetic process model.

Accordingly, the generation of a process model based on new master data is supported.

(8) According to (1) described above, when detecting a difference between the past synthetic process model and the new synthetic process model, the processor outputs information for notifying the manager of the process model of which of the actual process model and the master process model the difference is detected, and the content of the detected difference (for example, steps 812, 816, 828, 832).

As a result, the deviation between the state of the manufacturing site and the master data is quickly checked, and information indicating the content of the deviation is provided, thereby supporting the elimination of the deviation.

(9) According to (1) described above, the processor is configured to output information (for example, information displayed in the process model display units 1001, 1101, 1201, and 1301) for displaying the past actual process model, the new actual process model, the past master process model, the new master process model, the past synthetic process model, and the new synthetic process model.

As a result, it is possible to easily check whether there is a change of the state of the manufacturing site and the master data, and the deviation or synchronization between the two.

(10) According to (9) described above, the processor is configured to output information for displaying information in different modes indicating, among the tasks included in the synthetic process model, the execution order of the tasks included only in the actual process model, the execution order of the tasks included only in the master process model, and the execution order of the tasks included in both the actual process model and the master process.

It becomes possible to easily check the deviation between the state of the manufacturing site and the master data.

(11) According to (10) described above, the display in the different modes includes at least one of displaying using different shapes, and displaying using different colors.

It becomes possible to easily check the deviation between the state of the manufacturing site and the master data.

Note that the present disclosure is not limited to the embodiments described above, and includes various modifications. For example, although the embodiments described above have been described in detail for a better understanding of the present invention, the embodiments are not necessarily limited to those including all the configurations described above. A part of the configuration of an embodiment may be replaced with the configuration of another embodiment, and the configuration of another embodiment may be added to the configuration of an embodiment. It is possible to add, delete, and replace other configurations for a part of the configuration of each embodiment.

Each of the configurations, functions, processing units, processing means, and the like described above may be implemented by hardware by designing a part or all of those with, for example, an integrated circuit. Each of the configurations, functions, and the like described above may be implemented by software by interpreting and executing a program that implements each function by the processor. The information such as a program, a table, a file, and the like that implements each function may be stored in a storage device such as non-volatile semiconductor memories, a hard disk drive, a solid state drive (SSD), or a computer-readable non-transitory data storage medium such as an IC card, an SD card, DVD, and the like.

The control lines and the information lines show those considered to be necessary for explanation, and it is not necessarily limited that all the control lines and information lines are shown necessarily on the product. In practice, it may be considered that almost all components are connected to each other.

### REFERENCE SIGNS LIST

100 computer
110 master data manager
120 manufacturing site
130 process model manager
200 process model management system
210 business operator
211 process model management unit
212 information collection unit
213 master data storage unit
214 actual data accumulation unit
215 actual process model accumulation unit
216 master process model accumulation unit
217 synthetic process model accumulation unit
219 master data management terminal
221 process model management terminal

1. A process model management system comprising:
a processor and a storage device, wherein
the storage device is configured to store actual data indicating actual performance of tasks executed at a manufacturing site and master data including design information on an order of tasks to be executed, and
the processor is configured to
generate an actual process model including information on an execution order of the tasks based on the actual data,
generate a master process model including information on the execution order of the tasks based on the master data,
generate a synthetic process model that includes both information on the execution order of the tasks included in the actual process model and information on the execution order of the tasks included in the master process model,
when the actual data is changed, detect a difference between a past actual process model generated based on the actual data before change and a new actual process model generated based on the actual data after change,
when the master data is changed, detect a difference between a past master process model generated based on the master data before change and a new master process model generated based on the master data after change,
detect a difference between a past synthetic process model generated based on the actual process model and the master process model before the actual data and the master data are changed and a new synthetic process model generated based on the actual process model and the master process model after one of the actual data and the master data is changed, and
output a notification based on the detected difference.

2. The process model management system according to claim 1, wherein the processor is configured to output, as the notification to a supervisor for the manufacturing site, information indicating content of the detected difference between the past actual process model and the new actual process model.

3. The process model management system according to claim 2, wherein the processor is configured to
determine whether the new actual process model deviates from the master process model or matches the master process model, based on the difference between the new actual process model and the master process model,
when the new actual process model deviates from the master process model, output information indicating content of the difference between the new actual process model and the master process model, and a part to change in the master data to match the changed actual data as the notification to a manager of the master data, and
when the new actual process model matches the master process model, output information indicating that the new actual process model matches the master process model as the notification to a manager of the process model.

4. The process model management system according to claim 3, wherein the processor is configured to, when the new actual process model deviates from the master process model, generate a new synthetic process model based on the new actual process model and the master process model, regardless of approval or rejection of the manager of the process model.

5. The process model management system according to claim 1, wherein the processor is configured to output information indicating content of the detected difference between the past master process model and the new master process model as the notification to a manager of the master data.

6. The process model management system according to claim 5, wherein the processor is configured to
determine whether the new master process model deviates from the actual process model or matches the actual process model, based on the difference between the new master process model and the actual process model,
when the new master process model deviates from the actual process model, output information indicating the content of the difference between the new master process model and the actual process model, and a part to change in the manufacturing process at the manufacturing site to match the changed master data as the notification to a supervisor for the manufacturing site, and
when the new master process model matches the actual process model, output information indicating that the new master process model matches the actual process model as the notification to a manager of the process model.

7. The process model management system according to claim 6, wherein the processor is configured to
when the new master process model deviates from the actual process model and approval of the manager of the process model is obtained, generate the new synthetic process model based on the new master process model and the actual process model, and
when the new master process model deviates from the actual process model but the approval of the manager of the process model is not obtained, not generate the synthetic process model.

8. The process model management system according to claim 1, wherein the processor is configured to, when detecting a difference between the past synthetic process model and the new synthetic process model, output information for notifying the manager of the process model of which of the actual process model and the master process model the difference is detected, and the content of the detected difference.

9. The process model management system according to claim 1, wherein the processor is configured to output information for displaying the past actual process model, the new actual process model, the past master process model, the new master process model, the past synthetic process model, and the new synthetic process model.

10. The process model management system according to claim 9, wherein the processor is configured to output information for displaying information in different modes indicating, among the tasks included in the synthetic process model, the execution order of the tasks included only in the actual process model, the execution order of the tasks included only in the master process model, and the execution order of the tasks included in both the actual process model and the master process.

11. The process model management system according to claim 10, wherein the display in the different modes includes at least one of displaying using different shapes, and displaying using different colors.

12. A process model management method executed by a computer system including a processor and a storage device, wherein
the storage device is configured to store actual data indicating actual performance of tasks executed at a manufacturing site and master data including design information on an order of tasks to be executed, and
the process model management method includes
a procedure for the processor to generate an actual process model including information on an execution order of the tasks based on the actual data,
a procedure for the processor to generate a master process model including information on the execution order of the tasks based on the master data,
a procedure for the processor to generate a synthetic process model that includes both information on the execution order of the tasks included in the actual process model and information on the execution order of the tasks included in the master process model,
a procedure for the processor to, when the actual data is changed, detect a difference between a past actual process model generated based on the actual data before change and a new actual process model generated based on the actual data after change,
a procedure for the processor to, when the master data is changed, detect a difference between a past master process model generated based on the master data before change and a new master process model generated based on the master data after change,
a procedure for the processor to detect a difference between a past synthetic process model generated based on the actual process model and the master process model before the actual data and the master data are changed and a new synthetic process model generated based on the actual process model and the master process model after one of the actual data and the master data is changed, and
a procedure for the processor to output a notification based on the detected difference.
